(19) United States
(12) Patent Application Publication
(10) Pub. No.: US 2026/0092830 A1
(43) Pub. Date: Apr. 2, 2026

(54) POLARIZING FILM INSPECTION DEVICE AND POLARIZING FILM INSPECTION METHOD USING THE INSPECTION DEVICE

(71) Applicant: Samsung Display Co., LTD., Yongin-si (KR)

(72) Inventor: Hee Sung JI, Yongin-si (KR)

(21) Appl. No.: 19/208,960

(22) Filed: May 15, 2025

(30) Foreign Application Priority Data
Sep. 30, 2024 (KR) 10-2024-0132435

(51) Int. Cl. G01M 11/02

(52) U.S. Cl. CPC G01M 11/0278

(57) ABSTRACT

A polarizing film inspection device includes a jig on which a display device including a polarizing film and a display panel is seated, a polarizing filter disposed on an upper portion of an edge of the polarizing film and having a polarization angle different from a polarization angle of the polarizing film, a transmission lighting disposed on a lower portion of the edge of the polarizing film and emitting light toward the edge of the polarizing film, a camera disposed on an upper portion of the polarizing filter, and a control unit which determines whether the polarizing film is defective by analyzing an image captured by the camera.

This application claims priority to Korean Patent Application No. 10-2024-0132435, filed on Sep. 30, 2024, and all the benefits accruing therefrom under 35 U.S.C. § 119, the content of which in its entirety is herein incorporated by reference.

### BACKGROUND

### 1. Field

The present disclosure relates to a polarizing film inspection device and a polarizing film inspection method using the inspection device.

### 2. Description of the Related Art

Display devices may have advantages of superior luminance, driving voltage, and response speed characteristics and the ability to be multi-colored and are being applied to various products, especially smartphones. Such display devices may include a display panel including an organic light emitting element. In the organic light emitting element, a cathode electrode and an anode electrode are disposed around an organic light emitting layer connected to both the cathode electrode and the anode electrode, and visible light is generated from the organic light emitting layer when a voltage is applied to the cathode electrode and the anode electrode.

The display device may be formed by stacking several members, such as, for example, a polarizing film, a cover window, and a lower panel member, on the display panel. A process of stacking the polarizing film on the display panel includes a process of stacking a polarizing film larger than the display panel on the display panel and cutting and removing a portion of the polarizing film. During such a process, a crack may occur on a cut surface of the polarizing film.

### SUMMARY

Aspects of the present disclosure provide a polarizing film inspection device capable of preventing defects in a display device by inspecting cracks in a polarizing film to determine whether the polarizing film is defective, and a polarizing film inspection method using the inspection device.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, a polarizing film inspection device includes a jig on which a display device including a polarizing film and a display panel is seated, a polarizing filter disposed on an upper portion of an edge of the polarizing film and having a polarization angle different from a polarization angle of the polarizing film, a transmission lighting disposed on a lower portion of the edge of the polarizing film and emitting light toward the edge of the polarizing film, a camera disposed on an upper portion of the polarizing filter, and a control unit which determines whether the polarizing film is defective by analyzing an image captured by the camera.

The polarization angle of the polarizing filter is perpendicular to the polarization angle of the polarizing film.

The control unit determines whether the polarizing film is defective or not based on whether the light emitted by the transmission lighting is present in the image captured by the camera.

The control unit determines that the polarizing film is defective, based on determining that the light emitted by the transmission lighting is present in the image captured by the camera, and determines that the polarizing film is not defective, based on determining that the light emitted by the transmission lighting is not present in the image captured by the camera.

The polarizing film inspection device further includes a lens portion that guides light that passes through the polarizing film among the light emitted by the transmission lighting to the edge of the polarizing film to the camera.

The lens portion includes a tube lens disposed on a lower portion of the camera, an objective lens which is disposed at a lower portion of the tube lens and spaced apart from the tube lens, and a lens connection portion disposed between the tube lens and the objective lens.

The polarizing filter is disposed on a lower portion of the objective lens.

The polarizing film inspection device further includes a coaxial lighting which generates alignment light, and a lighting connection portion connecting the coaxial lighting and the lens portion, wherein the alignment light generated from the coaxial lighting passes through the lighting connection portion and the lens portion and is transmitted toward the transmission lighting.

The display device is seated on the jig such that the polarizing film is positioned at the lowest portion.

The polarizing film inspection device further includes a focusing portion which adjusts a focus of the camera on an interface between the polarizing film and the display panel.

The focusing portion includes a light emitting portion which emits focused light toward the interface between the polarizing film and the display panel, and a light receiving portion which receives the focused light reflected by the polarizing film.

According to an aspect of the present disclosure, a polarizing film inspection method includes seating a display device including a polarizing film and a display panel on a jig, aligning a camera and a transmission lighting, adjusting a focus of the camera onto an interface between the polarizing film and the display panel, passing light emitted from the transmission lighting through the polarizing film and the polarizing filter and receiving the light by the camera, and determining, by a control unit, whether the polarizing film is defective by analyzing the light received by the camera.

In the seating of the display device on the jig, the display device is seated on the jig such that the polarizing film is positioned at a lowest portion.

The aligning of the camera and the transmission lighting includes emitting alignment light from a coaxial lighting in an axial direction which is parallel to an axial direction of the camera, and moving, by the control unit, the camera or the transmission lighting such that the alignment light irradiates the transmission lighting.

The focusing of the focus of the camera onto the interface between the polarizing film and the display panel includes emitting focused light from a light emitting portion toward the display device, and receiving, by a light receiving portion, the focused light reflected by the display device.

The focusing of the focus of the camera onto the interface between the polarizing film and the display panel includes moving, by the control unit, the camera such that the focused light irradiates the interface of the polarizing film and the display panel and is reflected by the polarizing film.

A polarization angle of the polarizing filter is perpendicular to a polarization angle of the polarizing film.

The passing of the light emitted by the transmission lighting through the polarizing film and the polarizing filter and the receiving of the light by the camera includes passing the light emitted by the transmission lighting through the polarizing film, passing the light passing through the polarizing film through the polarizing filter, and receiving the light passing through the polarizing filter with the camera.

The receiving of the light passing through the polarizing filter with the camera includes passing the light passing through the polarizing filter through an objective lens, and passing the light passing through the objective lens through a tube lens and receiving the light with the camera.

In the determining, by the control unit, whether the polarizing film is defective by analyzing the light received by the camera, the control unit determines that the polarizing film is defective, based on determining that the light is received by the camera, and determines that the polarizing film is not defective, based on determining that the light is not received by the camera.

According to an aspect of the present disclosure, an electronic device includes a display device which is inspected by a polarizing film inspection device, wherein the polarizing film inspection device includes a jig on which a display device including a polarizing film and a display panel is seated, a polarizing filter disposed on an upper portion of an edge of the polarizing film and having a polarization angle different from a polarization angle of the polarizing film, a transmission lighting disposed on a lower portion of the edge of the polarizing film and emitting light toward the edge of the polarizing film, a camera disposed on an upper portion of the polarizing filter, and a control unit which determines whether the polarizing film is defective by analyzing an image captured by the camera.

According to the polarizing film inspection device and the polarizing film inspection method using the inspection device according to the present disclosure, the defects in the display device may be prevented by inspecting the cracks in the polarizing film that may occur during the process of stacking the polarizing film on the display panel to determine whether the polarizing film is defective.

The effects according to the embodiments of the present disclosure are not limited to those mentioned above and more various effects are included in the following description of the present disclosure.

### BRIEF DESCRIPTION OF THE DRAWINGS

The above and other aspects and features of the present disclosure will become more apparent by describing in detail example embodiments thereof with reference to the attached drawings, in which:

FIG. 1 is a plan view schematically illustrating a display device according to an example embodiment;

FIG. 2 is a side view schematically illustrating the display device of FIG. 1;

FIG. 3 is a cross-sectional view schematically illustrating a display panel of FIG. 1;

FIGS. 4 to 6 are side views illustrating a process of stacking a polarizing film on the display panel;

FIG. 7 is a schematic view illustrating a polarizing film inspection device according to an example embodiment of the present disclosure;

FIG. 8 is a schematic flowchart of a polarizing film inspection method according to an example embodiment of the present disclosure;

FIG. 9 is a view illustrating a state in which a display device is seated on a jig in the polarizing film inspection method according to an example embodiment of the present disclosure;

FIG. 10 is a view illustrating a state in which a camera and a transmission lighting are aligned in the polarizing film inspection method according to an example embodiment of the present disclosure;

FIG. 11 is an enlarged view of part A of FIG. 10;

FIG. 12 is a view illustrating a state in which a focus of a camera is focused in the polarizing film inspection method according to an example embodiment of the present disclosure;

FIG. 13 is an enlarged view of part B of FIG. 12;

FIG. 14 is a view illustrating a state in which light emitted by the transmission lighting passes through a polarizing film and a polarizing filter and is received by the camera in the polarizing film inspection method according to an example embodiment of the present disclosure; and

FIG. 15 is an enlarged view of part C of FIG. 14.

FIG. 16 is a block diagram of an electronic device according to an embodiment of the present disclosure.

FIG. 17 is a schematic diagram of an electronic device according to various embodiments of the present disclosure.

### DETAILED DESCRIPTION

Advantages and features of the present disclosure and methods to achieve them will become apparent from the descriptions of example embodiments hereinbelow with reference to the accompanying drawings. However, the present disclosure is not limited to example embodiments disclosed herein but may be implemented in various different ways. The example embodiments are provided for making the disclosure of the present disclosure thorough and for fully conveying the scope of the present disclosure to those skilled in the art. It is to be noted that the scope of the present disclosure is defined by the claims.

As used herein, a phrase “an element A on an element B” refers to that the element A may be disposed directly on the element B and/or the element A may be disposed indirectly on the element B via another element C. Like reference numerals denote like elements throughout the descriptions. The figures, dimensions, ratios, angles, numbers of elements given in the drawings are illustrative and are not limiting.

Although terms such as first, second, and the like are used to distinguish arbitrarily between the elements such terms describe, and thus these terms are not necessarily intended to indicate temporal or other prioritization of such elements. These terms are used to distinguish one element from another. Accordingly, as used herein, a first element may be a second element within the technical scope of the present disclosure.

Features of various example embodiments of the present disclosure may be combined partially or totally. As will be clearly appreciated by those skilled in the art, technically various interactions and operations are possible. Various example embodiments can be practiced individually or in combination.

Hereinafter, example embodiments of the present disclosure will be described in detail with reference to the accompanying drawings.

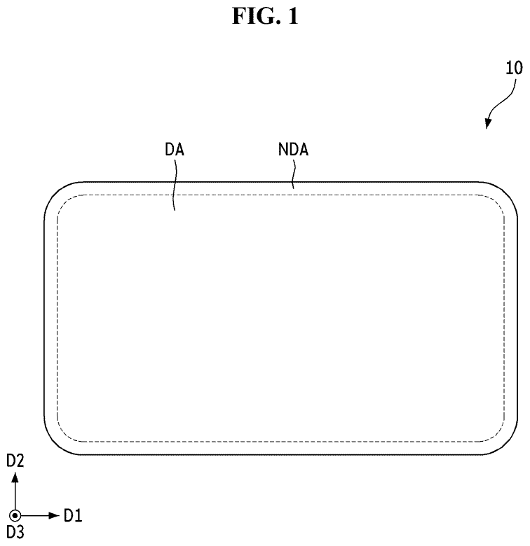

FIG. 1 is a plan view schematically illustrating a display device according to an example embodiment.

A display device 10, which is a device that displays a moving image or a still image, may be used as a display screen of each of various products, such as, for example, a television, a laptop computer, a monitor, a billboard, and Internet of Things (IOT), as well as portable electronic devices such as, for example, a mobile phone, a smart phone, a tablet personal computer (PC), a smart watch, a watch phone, a mobile communication terminal, an electronic organizer, an electronic book, a portable multimedia player (PMP), a navigation device, and an ultra mobile PC (UMPC). Alternatively, the display device 10 may be used as a display screen applied to a center fascia of a vehicle.

The display device 10 may be a light emitting display device such as, for example, an organic light emitting display device using an organic light emitting diode, a quantum dot light emitting display device including a quantum dot light emitting layer, an inorganic light emitting display device including an inorganic semiconductor, and a micro light emitting display device using a micro light emitting diode (LED). Hereinafter, it is mainly described that the display device 10 is the organic light emitting display device, but embodiments of the present disclosure are not limited thereto.

In FIG. 1, a first direction D1 may be a direction parallel to one side of the display device 10 when viewed on a plane, for example, a horizontal direction of the display device 10. A second direction D2 may be a direction parallel to the other side in contact with one side of the display device 10 when viewed on a plane, and may be a vertical direction of the display device 10. A third direction D3 may be a thickness direction of the display device 10.

A planar shape of the display device 10 may be a quadrangular shape such as, for example, a rectangle. For example, the display device 10 may have a rectangular planar shape having long sides in the first direction D1 and short sides in the second direction D2. A corner where the long side in the first direction D1 and the short side in the second direction D2 meet may be rounded to have a predetermined curvature or may be formed at a right angle. The planar shape of the display device 10 is not limited to the rectangle, and may be formed in other polygonal, circular, or oval shapes.

The display device 10 may include a display area DA and a non-display area NDA. A planar shape of the display area DA may follow the shape of the display device 10. In an example in which the planar shape of the display device 10 is a rectangle, the planar shape of the display area DA may also be a rectangle.

The display area DA may be an area including a plurality of pixels to display an image. The non-display area NDA may be an area that does not include the pixels and does not display the image. The non-display area NDA may be disposed around the display area DA. The non-display area NDA may be disposed to surround the display area DA, but the example embodiment of embodiments of the present disclosure are not limited thereto. The display area DA may be partially surrounded by the non-display area NDA.

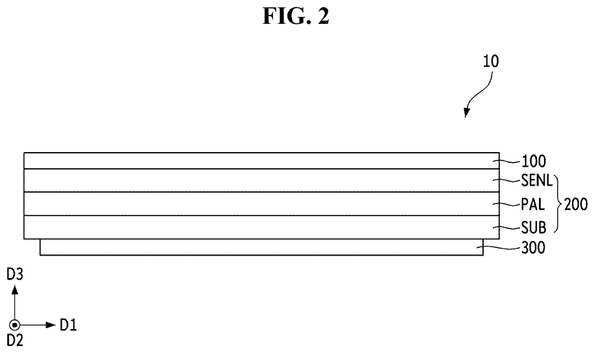

FIG. 2 is a side view schematically illustrating the display device of FIG. 1.

Referring to FIG. 2, the display device 10 may include a polarizing film 100, a display panel 200, and a panel lower member 300.

The polarizing film 100 may be disposed on the display panel 200. The polarizing film 100 may serve to prevent deterioration in image visibility of the display panel 200 due to reflection of external light. The polarizing film 100 may include a linear polarizing plate and a retardation film such as, for example, a λ/4 plate (quarter-wave plate). The phase retardation film may be disposed on the display panel 200, and the linear polarizing plate may be disposed on the phase retardation film. A cover window (not illustrated) may be disposed on the polarizing film 100.

The display panel 200 may be disposed below the polarizing film 100. The display panel 200 may have a rectangular planar shape having long sides in the first direction D1 and short sides in the second direction D2. In the display panel 200, a corner where the long side in the first direction D1 and the short side in the second direction D2 meet may be formed at a right angle or may be rounded to have a predetermined curvature. The display panel 200 may have a planar shape of other quadrangles other than the rectangle and other polygons, circles, ellipses, or irregular shapes other than the quadrangle.

The display panel 200 may include a substrate SUB, a display unit PAL, and a sensor unit SENL.

The substrate SUB may be formed of an insulating material such as, for example, glass, quartz, or a polymer resin. The substrate SUB may be a rigid substrate or a flexible substrate that may be bent, folded, and rolled.

The display unit PAL may be disposed on the substrate SUB. The display unit PAL may be a layer including a plurality of light emitting areas that emit light. The display unit PAL may include a buffer film, a thin film transistor layer on which thin film transistors are disposed, a light emitting element layer that emits light, and an encapsulation layer for encapsulating the light emitting element layer.

The sensor unit SENL may be disposed on the display unit PAL. The sensor unit SENL may include sensor electrodes and may be a layer for sensing whether a user's touch has been made.

The panel lower member 300 may be disposed below the substrate SUB. The panel lower member 300 may be attached to a lower surface of the substrate SUB through an adhesive member. The adhesive member may be a pressure sensitive adhesive (PSA). The panel lower member 300 may include at least one of a light absorbing member for absorbing light incident from the outside, a buffer member for absorbing a shock from the outside, and a heat dissipation member for efficiently dissipating heat of the display panel 200.

The light absorbing member may be disposed below the substrate SUB. The light absorbing member blocks transmission of light, thereby preventing components disposed below the light absorbing member, such as, for example, a driving circuit board (not illustrated), from being viewed from an upper portion of the display panel 200. The light absorbing member may include a light absorbing material such as, for example, a black pigment or a black dye.

The buffer member may be disposed below the light absorbing member. The buffer member absorbs the external shock to prevent damage to the display panel 200. The buffer member may be formed as a single layer or a plurality of layers. For example, the buffer member may be formed of a polymer resin such as, for example, polyurethane, polycarbonate, polypropylene, or polyethylene, or may include a material having elasticity, such as, for example, a sponge made by foaming and molding rubber, urethane-based materials, or acrylic-based materials.

The heat dissipation member may be disposed below the buffer member. The heat dissipation member may include a first heat dissipation layer including graphite or carbon nanotubes, and a second heat dissipation layer formed of a thin metal film such as, for example, copper, nickel, ferrite, or silver that may shield electromagnetic waves and has excellent thermal conductivity.

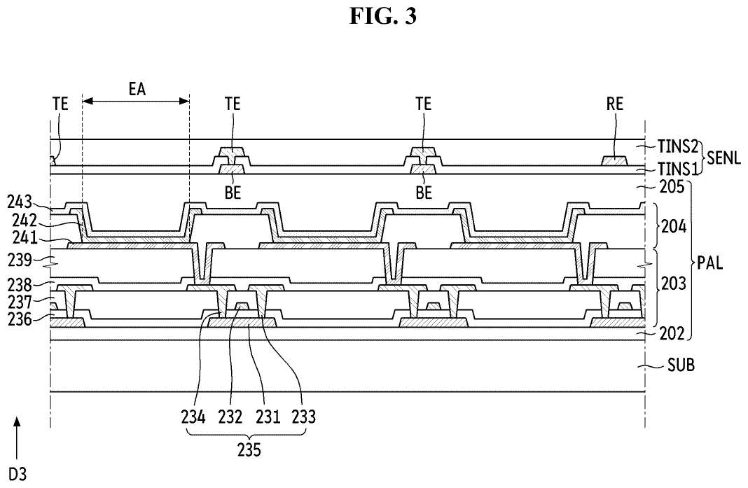

FIG. 3 is a cross-sectional view schematically illustrating a display panel of FIG. 1.

Referring to FIG. 3, the display unit PAL may include a buffer film 202, a thin film transistor layer 203, a light emitting element layer 204, and an encapsulation layer 205.

A buffer film 202 may be formed on the substrate SUB. The buffer film 202 may be formed on the substrate SUB to protect thin film transistors 235 and light emitting elements from moisture permeating through the substrate SUB that is vulnerable to moisture permeation. The buffer film 202 may include a plurality of inorganic films that are alternately stacked. For example, the buffer film 202 may be formed as a multi-film in which one or more inorganic films of a silicon oxide film (SiOx), a silicon nitride film (SiNx), and SiON are alternately stacked. The buffer film 202 may be omitted.

A thin film transistor layer 203 is formed on the buffer film 202. The thin film transistor layer 203 includes thin film transistors 235, a gate insulating film 236, an interlayer insulating film 237, a protective film 238, and an organic film 239.

Each of the thin film transistors 235 includes an active layer 231, a gate electrode 232, a source electrode 233, and a drain electrode 234. It is illustrated in FIG. 3 that the thin film transistor 235 is formed in a top gate type in which the gate electrode 232 is positioned above the active layer 231, but embodiments of the present disclosure are not limited thereto. That is, the thin film transistors 235 may be formed in a bottom gate type in which the gate electrode 232 is positioned below the active layer 231 or a double gate type in which the gate electrodes 232 are positioned both above and below the active layer 231.

The active layer 231 is formed on the buffer film 202. The active layer 231 may be formed of a silicon-based semiconductor material or an oxide-based semiconductor material. For example, the active layer 231 may be formed of polysilicon, amorphous silicon, or an oxide semiconductor. A light blocking layer for blocking external light incident to the active layer 231 may be formed between the buffer film 202 and the active layer 231.

The gate insulating film 236 may be formed on the active layer 231. The gate insulating film 236 may be formed as an inorganic film, for example, a silicon oxide film (SiOx), a silicon nitride film (SiNx), or a multi-film thereof.

The gate electrode 232 may be formed on the gate insulating film 236. The gate electrode 232 and the gate line may be formed as a single layer or a multi-layer formed of any one of molybdenum (Mo), aluminum (Al), chromium (Cr), gold (Au), titanium (Ti), nickel (Ni), neodymium (Nd), and copper (Cu), or an alloy thereof.

The interlayer insulating film 237 may be formed on the gate electrode 232 and the gate line. The interlayer insulating film 237 may be formed as an inorganic film, for example, a silicon oxide film (SiOx), a silicon nitride film (SiNx), or a multi-film thereof.

A source electrode 233 and a drain electrode 234 may be formed on the interlayer insulating film 237. Each of the source electrode 233 and the drain electrode 234 may be connected to the active layer 231 through a contact hole penetrating through the gate insulating film 236 and the interlayer insulating film 237. The source electrode 233 and the drain electrode 234 may be formed as a single layer or a multi-layer formed of any one of molybdenum (Mo), aluminum (Al), chromium (Cr), gold (Au), titanium (Ti), nickel (Ni), neodymium (Nd), and copper (Cu), or an alloy thereof.

A protective film 238 for insulating the thin film transistor 235 may be formed on the source electrode 233 and the drain electrode 234. The protective film 238 may be formed as an inorganic film, for example, a silicon oxide film (SiOx), a silicon nitride film (SiNx), or a multi-film thereof.

An organic film 239 for planarizing a step caused by the thin film transistor 235 may be formed on the protective film 238. The organic film 239 may be formed as an organic film formed of an acrylic resin, an epoxy resin, a phenolic resin, a polyamide resin, or a polyimide resin.

A light emitting element layer 204 is formed on the thin film transistor layer 203. The light emitting element layer 204 includes light emitting elements and a bank.

The light emitting elements and the bank are formed on the organic film 239. In an example, the light emitting element is an organic light emitting element including an anode electrode 241, light emitting layers 242, and a cathode electrode 243.

The anode electrode 241 may be formed on the organic film 239. The anode electrode 241 may be connected to the source electrode 233 of the thin film transistor 235 through a contact hole penetrating through the protective film 238 and the organic film 239.

The bank may be formed such that the bank covers an edge of the anode electrode 241 on the organic film 239 and partitions the light emitting areas EA of the pixels. That is, the bank serves to define the light emitting areas EA of the pixels. Each of the pixels represents an area in which the anode electrode 241, the light emitting layer 242, and the cathode electrode 243 are sequentially stacked, and holes from the anode electrode 241 and electrons from the cathode electrode 243 are bonded to each other in the light emitting layer 242 to emit light.

The light emitting layers 242 are formed on the anode electrode 241 and the bank. The light emitting layer 242 may be an organic light emitting layer. The light emitting layer 242 may emit one of red light, green light, and blue light. Alternatively, the light emitting layer 242 may be a white light emitting layer that emits white light. In this case, the light emitting layer 242 may have a form in which a red light emitting layer, a green light emitting layer, and a blue light emitting layer are stacked, and the light emitting layer 242 may be a common layer commonly formed in the pixels. In this case, the display panel 200 may further include separate color filters for respectively displaying red light green light, and blue light.

The light emitting layer 242 may include a hole transporting layer, a light emitting layer, and an electron transporting layer. In some aspects, the light emitting layer 242 may be formed in a tandem structure of two or more stacks, in which case a charge generation layer may be formed between the stacks.

The cathode electrode 243 is formed on the light emitting layer 242. The cathode electrode 243 as formed may cover the light emitting layer 242. The cathode electrode 243 may be a common layer formed commonly in the pixels.

When the light emitting element layer 204 is formed in a top emission structure in which light is emitted in an upward direction, the anode electrode 241 may be formed of a metal material having high reflectivity, such as, for example, a stacked structure (Ti/Al/Ti) of aluminum and titanium, a stacked structure (ITO/Al/ITO) of aluminum and indium tin oxide (ITO), an APC alloy, and a stacked structure (ITO/APC/ITO) of an APC alloy and ITO. The APC alloy is an alloy of silver (Ag), palladium (Pd), and copper (Cu). In some aspects, the cathode electrode 243 may be formed of a transparent conductive material (TCO) such as, for example, ITO or indium zinc oxide (IZO) capable of transmitting light, or a semi-transmissive conductive material such as, for example, magnesium (Mg), silver (Ag), or an alloy of magnesium (Mg) and silver (Ag). In an example in which the cathode electrode 243 is formed of the semi-transmissive conductive material, light emission efficiency may be increased by a micro cavity.

When the light emitting element layer 204 is formed in the bottom emission structure in which light is emitted in a downward direction, the anode electrode 241 may be formed of a transparent conductive material (TCO) such as, for example, ITO or IZO, or a semi-transmissive conductive material such as, for example, magnesium (Mg), silver (Ag), or an alloy of magnesium (Mg) and silver (Ag). The cathode electrode 243 may be formed of a metal material having high reflectivity, such as, for example, a stacked structure (Ti/Al/Ti) of aluminum and titanium, a stacked structure (ITO/Al/ITO) of aluminum and ITO, an APC alloy, and a stacked structure (ITO/APC/ITO) of an APC alloy and ITO. In an example in which the anode electrode 241 is formed of the semi-transmissive conductive material, light emission efficiency may be increased by a micro cavity.

An encapsulation layer 205 is formed on the light emitting element layer 204. The encapsulation layer 205 serves to prevent oxygen or moisture from permeating into the light emitting layer 242 and the cathode electrode 243. To this end, the encapsulation layer 205 may include at least one inorganic film. The inorganic film may be formed of silicon nitride, aluminum nitride, zirconium nitride, titanium nitride, hafnium nitride, tantalum nitride, silicon oxide, aluminum oxide, or titanium oxide. In some aspects, the encapsulation layer 205 may further include at least one organic film. The organic film may be formed to a sufficient thickness to prevent particles from penetrating through the encapsulation layer 205 and entering the light emitting layer 242 and the cathode electrode 243. The organic film may include any one of epoxy, acrylate or urethane acrylate.

A sensor unit SENL may be formed on the encapsulation layer 205. In an example in which the sensor unit SENL is formed directly on the encapsulation layer 205, there is an advantage in that a thickness of the display device 10 may be reduced compared to when a separate touch panel is attached onto the encapsulation layer 205.

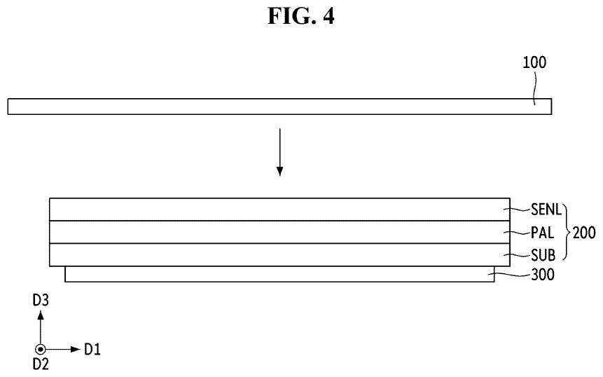

The sensor unit SENL may include touch electrodes for sensing a user's touch in a capacitance method, and touch lines connecting the pads and the touch electrodes. For example, the sensor unit SENL may sense a user's touch in a self-capacitance method or a mutual capacitance method. It is mainly described in FIG. 4 that the sensor unit SENL is formed in a two-layer mutual capacitance method including driving electrodes TE, sensing electrodes RE, and connecting portions BE connecting the driving electrodes TE.

The connection portions BE may be formed on the encapsulation layer 205. The connection portions BE may be formed in a stacked structure (Ti/Al/Ti) of aluminum and titanium, a stacked structure (ITO/Al/ITO) of aluminum and ITO, an APC alloy, and a stacked structure (ITO/APC/ITO) of an APC alloy and ITO, but are limited thereto. For example, the connection portions BE may be formed of a single layer of molybdenum (Mo), titanium (Ti), copper (Cu), aluminum (Al), or ITO.

A first sensing insulating film TINS1 is formed on the connection portions BE. The first sensing insulating film TINS1 may be formed as an inorganic film, for example, a silicon nitride layer, a silicon oxynitride layer, a silicon oxide layer, a titanium oxide layer, or an aluminum oxide layer.

The driving electrodes TE and the sensing electrodes RE may be disposed on the first sensing insulating film TINS1. The driving electrodes TE and the sensing electrodes RE may be formed in a stacked structure (Ti/Al/Ti) of aluminum and titanium, a stacked structure (ITO/Al/ITO) of aluminum and ITO, an APC alloy, and a stacked structure (ITO/APC/ITO) of an APC alloy and ITO, but are limited thereto. For example, the driving electrodes TE and the sensing electrodes RE may be formed of a single layer of molybdenum (Mo), titanium (Ti), copper (Cu), aluminum (Al), or ITO.

Contact holes that penetrate through the first sensing insulating film TINS1 and expose the connection portion BE may be formed in the first sensing insulating film TINS1. The driving electrodes TE may be connected to the connection portions BE through the contact holes.

A second sensing insulating film TINS2 is formed on the driving electrodes TE and the sensing electrodes RE. The second sensing insulating film TINS2 may serve to planarize a step formed due to the driving electrodes TE, the sensing electrodes RE, and the connection portions BE. The second sensing insulating film TINS2 may be formed as an organic film formed of an acryl resin, an epoxy resin, a phenolic resin, a polyamide resin, a polyimide resin, or the like.

The connection portions BE connecting the driving electrodes TE adjacent to each other may be disposed on the encapsulation layer 205, and the driving electrodes TE and the sensing electrodes RE may be disposed on the first sensing insulating film TINS1. Therefore, the driving electrodes TE and the sensing electrodes RE may be electrically separated at their intersections, the sensing electrodes RE may be electrically connected in one direction, and the driving electrodes TE may be electrically connected in the other direction.

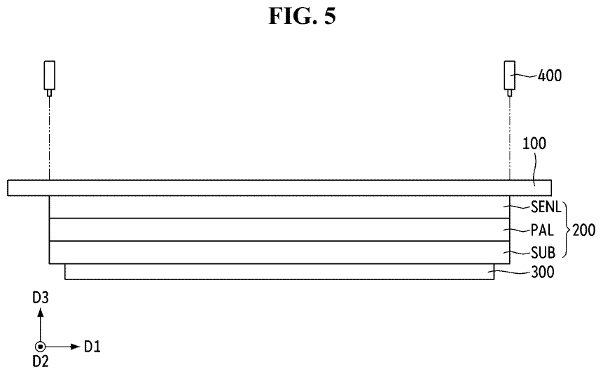

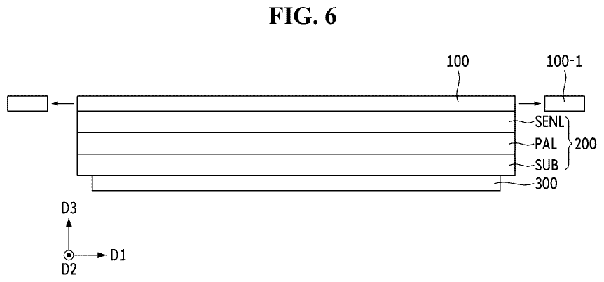

FIGS. 4 to 6 are side views illustrating a process of stacking a polarizing film on the display panel.

A process of stacking a polarizing film 100 on the display panel 200 will be described with reference to FIGS. 4 to 6.

A polarizing film 100 having a size greater than the size of the display panel 200 may be stacked on the display panel 200. The polarizing film 100 stacked on the display panel 200 may be attached onto the display panel 200 by a separate adhesive layer (not illustrated).

After the polarizing film 100 is attached onto the display panel 200, a removal process of removing a portion of the polarizing film 100 may be performed. A portion of the polarizing film 100 removed in the removal process may be removed by being cut by a laser irradiated from a laser irradiator 400. By the above-described removal process, the polarizing film 100 may be formed to a size corresponding to the display panel 200.

In the process of stacking the polarizing film 100 on the display panel 200 and removing a portion of the polarizing film 100, cracks may occur on a cut surface of the polarizing film 100.

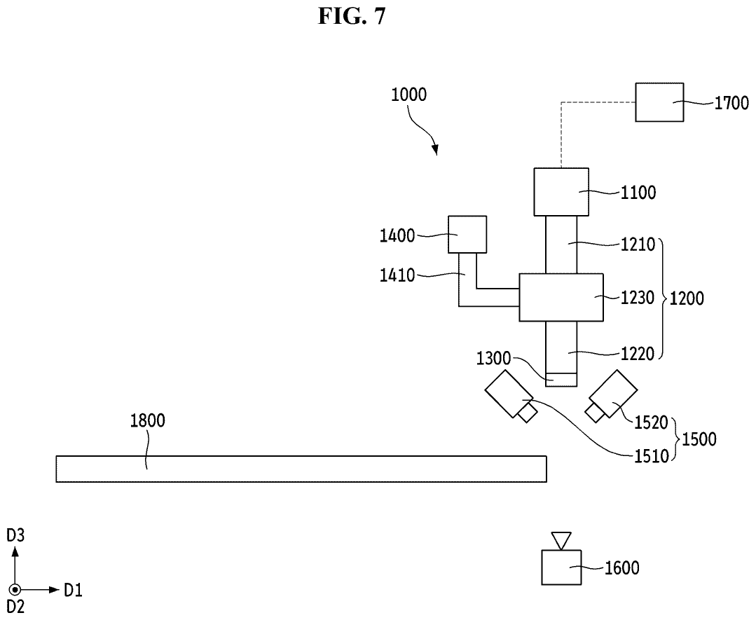

FIG. 7 is a schematic view illustrating a polarizing film inspection device according to an example embodiment of the present disclosure.

Referring to FIG. 7, a polarizing film inspection device 1000 according to an example embodiment of the present disclosure may inspect cracks that may occur on an edge of the polarizing film 100. The polarizing film inspection device 1000 may include a camera 1100, a lens portion 1200, a polarizing filter 1300, a coaxial lighting 1400, a lighting connection portion 1410, a focusing portion 1500, a transmission lighting 1600, a control unit 1700, and a jig 1800.

The camera 1100 may be disposed on an upper portion of the display device 10. The camera 1100 may be disposed on an upper portion of the edge of the polarizing film 100 of the upper portion of the display device 10. In some aspects, the camera 1100 may be disposed on an upper portion of a polarizing filter 1300 which is disposed on the upper portion of the edge of the polarizing film 100. The camera 1100 may receive light that sequentially passes through the polarizing film 100 and the polarizing filter 1300. The light that sequentially passes through the polarizing film 100 and the polarizing filter 1300 may be light emitted by the transmission lighting 1600.

The lens portion 1200 may guide the light that has passed through the polarizing film 100 and the polarizing filter 1300 of the light emitted by the transmission lighting 1600 to the camera 1100. The lens portion 1200 may include a tube lens 1210, an objective lens 1220, and a lens connection portion 1230.

The tube lens 1210 may be disposed on a lower portion of the camera 1100 such that the tube lens 1210 is disposed between the camera 1100 and the objective lens 1220. The tube lens 1210 may serve to accurately focus and transmit light passing through the objective lens 1220 and polarizing filter 1300 to an image sensor of the camera 1100.

The objective lens 1220 may be disposed on the upper portion of the edge of the polarizing film 100 such that the objective lens 1220 is disposed between the polarizing filter 1300 and the tube lens 1210. The objective lens 1220 may be disposed on the polarizing filter 1300. The objective lens 1220 may transmit the light that has passed through the polarizing film 100 and the polarizing filter 1300 of the light emitted by the transmission lighting 1600. The objective lens 1220 may serve to form an image by collecting the light passing through the polarizing film 100 and the polarizing filter 1300.

The lens connection portion 1230 may be disposed between the tube lens 1210 and the objective lens 1220. The lens connection portion 1230 may connect the tube lens 1210 and the objective lens 1220 and provide a path through which light passing through the objective lens 1220 may move to the tube lens 1210.

The polarizing filter 1300 may be disposed on the upper portion of the edge of the polarizing film 100. The polarizing filter 1300 may be disposed on a lower portion of the objective lens 1220. The polarizing filter 1300 may be disposed to have a polarization angle different from the polarization angle of the polarizing film 100. The polarization angle of the polarizing filter 1300 may be perpendicular to the polarization angle of the polarizing film 100. Since the polarization angle of the polarizing filter 1300 is perpendicular to the polarization angle of the polarizing film 100, the light passing through the polarizing film 100 may be blocked by the polarizing filter 1300.

The coaxial lighting 1400 may generate alignment light. The coaxial lighting 1400 may irradiate the alignment light in the same axial direction as the camera 1100. The alignment light generated from the coaxial lighting 1400 may pass through the lighting connection portion 1410 and the lens portion 1200 and travel toward the transmission lighting 1600. The alignment light may travel to the transmission lighting 1600 sequentially through the lighting connection portion 1410, the lens connection portion 1230, and the objective lens 1220.

The lighting connection portion 1410 may connect the coaxial lighting 1400 and the lens connection portion 1230. The lighting connection portion 1410 may provide a path for the alignment light generated from the coaxial lighting 1400 to move to the lens connection portion 1230.

The focusing portion 1500 may adjust or fix a focus of the camera 1100 to an interface between the polarizing film 100 and the display panel 200. The focusing portion 1500 may include a light emitting portion 1510 and a light receiving portion 1520.

The light emitting portion 1510 may irradiate the focused light to the display device 10. The light emitting portion 1510 may irradiate the focused light to the display device 10 in an oblique direction rather than a direction perpendicular to the display device 10.

The light receiving portion 1520 may receive the focused light reflected by the display device 10.

The transmission lighting 1600 may be disposed on a lower portion of the edge of the polarizing film 100. The transmission lighting 1600 may emit light toward the edge of the polarizing film 100. The light emitted by the transmission lighting 1600 may sequentially pass through the polarizing film 100, the polarizing filter 1300, and the lens portion 1200 and be received by the camera 1100.

The control unit 1700 may analyze an image captured by the camera 1100 to determine whether the polarizing film 100 is defective. In some embodiments, the control unit 1700 may analyze the light received by the camera 1100 to determine whether the polarizing film 100 is defective. The control unit 1700 may determine whether the polarizing film 100 is defective or not based on whether the light emitted by the transmission lighting 1600 is present in the image captured by the camera 1100.

The control unit 1700 may determine that the polarizing film 100 is defective, based on determining that the light emitted by the transmission lighting 1600 is present in the image captured by the camera 1100. The light emitted by the transmission lighting 1600 may pass through the edge of the polarizing film 100, then pass through the polarizing filter 1300 and move to the objective lens 1220. Since the polarization angle of the polarizing filter 1300 is perpendicular to the polarization angle of the polarizing film 100, the light passing through the polarizing film 100 may be blocked by the polarizing filter 1300 when the cracks do not occur on the polarizing film 100. However, when the cracks occur on the polarizing film 100, the polarization angle may change as the light passes through the cracks, and the light with the changed polarization angle may pass through the polarizing filter 1300 and be received by the camera 1100. Therefore, when the cracks occur on the polarizing film 100, some of the light passing through the polarizing film 100 passes through the polarizing filter 1300 and is received by the camera 1100. As a result, the light may be present in the image captured by the camera 1100.

In some embodiments, the control unit 1700 may determine that the polarizing film 100 is not defective, based on determining that the light emitted by the transmission lighting 1600 is not present in the image captured by the camera 1100. The light emitted by the transmission lighting 1600 may pass through the edge of the polarizing film 100, then pass through the polarizing filter 1300 and move to the objective lens 1220. Since the polarization angle of the polarizing filter 1300 is perpendicular to the polarization angle of the polarizing film 100, the light passing through the polarizing film 100 may be blocked by the polarizing filter 1300 when the cracks do not occur on the polarizing film 100. Therefore, when the cracks do not occur on the polarizing film 100, the light passing through the polarizing film 100 is blocked by the polarizing filter 1300. As a result, the light may not be present in the image captured by the camera 1100.

Descriptions herein of light passing through an element (e.g., the polarizing film 100, the polarizing filter 1300, the lens portion 1200, tube lens 1210, objective lens 1220, or the like) may also be referred to as the element transmitting the light.

In some aspects, the control unit 1700 may move the camera 1100 or the transmission lighting 1600 such that the alignment light emitted by the coaxial lighting 1400 irradiates the transmission lighting 1600. Since the alignment light emitted by the coaxial lighting 1400 is emitted in the same axial direction as the camera 1100, the camera 1100 and the transmission lighting 1600 may be seen to be aligned on the same axis, when the alignment light irradiates the transmission lighting 1600. The control unit 1700 may align the camera 1100 and the transmission lighting 1600 on the same axis by moving the camera 1100 or the transmission lighting 1600 such that the alignment light irradiates the transmission lighting 1600.

In some aspects, the control unit 1700 may move the camera 1100 such that the focused light emitted by the light emitting portion 1510 irradiates the interface between the polarizing film 100 and the display panel 200, and the focused light reflected by the polarizing film 100 is received by the light receiving portion 1520. Since a point where the focused light emitted by the light emitting portion 1510 is reflected becomes the focus of the camera 1100, the control unit 1700 may move the camera 1100 such that the focus of the camera 1100 is positioned at the interface between the polarizing film 100 and the display panel 200.

The jig 1800 may support the display device 10. The jig 1800 may be disposed below the polarizing filter 1300 and above the transmission lighting 1600. In some embodiments, the jig 1800 may be disposed between the polarizing filter 1300 and the transmission lighting 1600 and support the display device 10. The display device 10 may be seated on an upper surface of the jig 1800 and supported by the jig 1800. The display device 10 may be seated on the jig 1800 such that the polarizing film 100 is positioned at the lowest portion. In some embodiments, the display device 10 may be seated on the jig 1800 such that the polarizing film 100 is in contact with the upper surface of the jig 1800.

Hereinafter, a polarizing film inspection method according to an example embodiment of the present disclosure will be described with reference to the drawings.

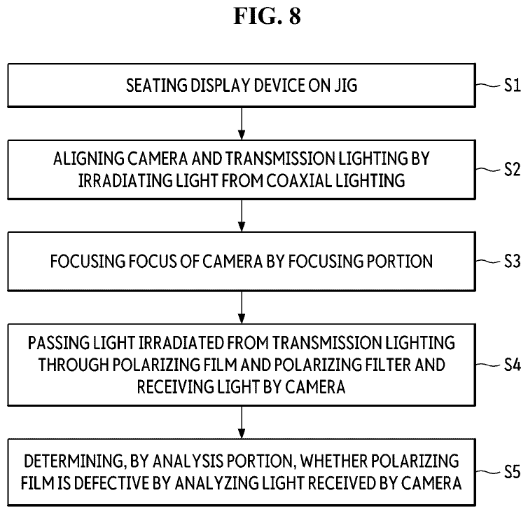

FIG. 8 is a schematic flowchart of a polarizing film inspection method according to an example embodiment of the present disclosure.

In the descriptions of the method and processes herein, the operations may be performed in a different order than the order shown and/or described, or the operations may be performed in different orders or at different times. Certain operations may also be left out of the flowcharts, one or more operations may be repeated, or other operations may be added.

Referring to FIG. 8, a polarizing film inspection method according to an example embodiment of the present disclosure may include a step S1 of seating a display device 10 on a jig 1800, a step S2 of aligning a camera 1100 and a transmission lighting 1600, a step S3 of adjusting (i.e., fixing, setting, or modifying) a focus of the camera 1100 onto an interface between a polarizing film 100 and a display panel 200, a step S4 of receiving, by the camera 1100, light which is emitted by the transmission lighting 1600 and passes through the polarizing film 100 and a polarizing filter 1300, and a step S5 in which a control unit 1700 determines whether the polarizing film 100 is defective by analyzing the light received by the camera 1100.

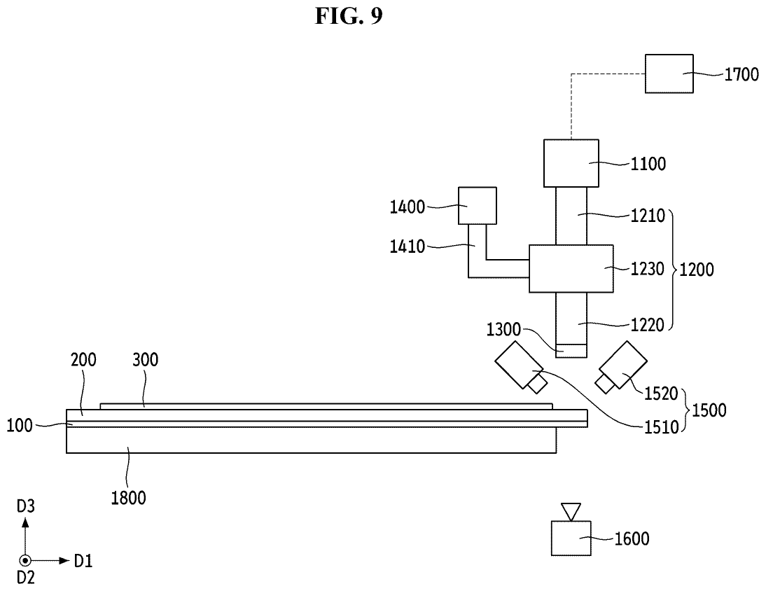

FIG. 9 is a view illustrating a state in which a display device is seated on a jig in the polarizing film inspection method according to an example embodiment of the present disclosure.

Referring to FIG. 9, in the step of seating the display device 10 on the jig 1800, the display device 10 may be seated on an upper surface of the jig 1800 and supported by the jig 1800. The display device 10 may be seated on the jig 1800 such that the polarizing film 100 is positioned at the lowest portion of the display device 10. In some embodiments, the display device 10 may be seated on the jig 1800 such that the polarizing film 100 is in contact with the upper surface of the jig 1800.

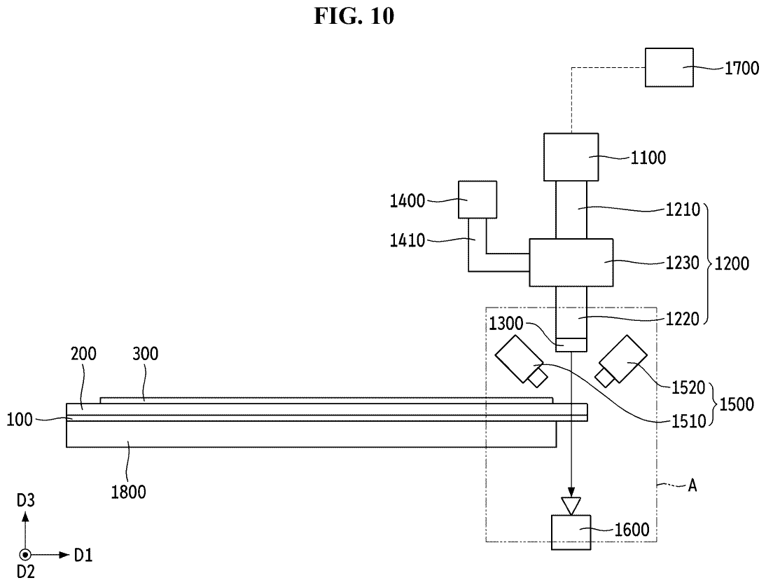

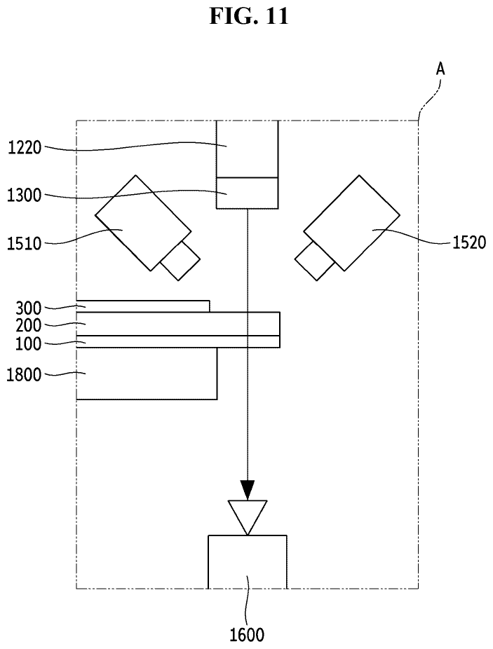

FIG. 10 is a view illustrating a state in which a camera and a transmission lighting are aligned in the polarizing film inspection method according to an example embodiment of the present disclosure. FIG. 11 is an enlarged view of part A of FIG. 10.

Referring to FIGS. 10 and 11, the step of aligning the camera 1100 and the transmission lighting 1600 may include a step in which alignment light is emitted in the same axial direction as the camera 1100 from a coaxial lighting 1400 and a step in which the control unit 1700 moves the camera 1100 or the transmission lighting 1600 such that the alignment light irradiates the transmission lighting 1600. For example, the polarizing film inspection method may include emitting the alignment light from the coaxial lighting 1400 in an axial direction of the coaxial lighting 1400, and the axial direction of the coaxial lighting 1400 may be parallel to the axial direction of the camera 1100.

In the step in which the alignment light is emitted in the same axial direction as the camera 1100 from the coaxial lighting 1400, the coaxial lighting 1400 may generate alignment light and irradiate the generated alignment light in the same axial direction as the camera 1100. The alignment light generated from the coaxial lighting 1400 may pass through the lighting connection portion 1410 and the lens portion 1200 and travel toward the transmission lighting 1600. The alignment light may travel toward the transmission lighting 1600 sequentially through the lighting connection portion 1410, the lens connection portion 1230, the objective lens 1220, and the polarizing filter 1300 and irradiate the transmission lighting 1600.

In the step in which the control unit 1700 moves the camera 1100 or the transmission lighting 1600 such that the alignment light irradiates the transmission lighting 1600, the control unit 1700 may move the camera 1100 or the transmission lighting 1600 such that the alignment light emitted by the coaxial lighting 1400 irradiates the transmission lighting 1600. Since the alignment light emitted by the coaxial lighting 1400 is emitted in the same axial direction as the camera 1100, the camera 1100 and the transmission lighting 1600 may be seen to be aligned on the same axis, when the alignment light irradiates the transmission lighting 1600. The control unit 1700 may align the camera 1100 and the transmission lighting 1600 on the same axis by moving the transmission lighting 1600 such that the alignment light irradiates the transmission lighting 1600. Since the coaxial lighting 1400 is coupled to the camera 1100 and moves together with the camera 1100, the control unit 1700 may move the camera 1100 such that the alignment light emitted from the coaxial lighting 1400 irradiates the transmission lighting 1600.

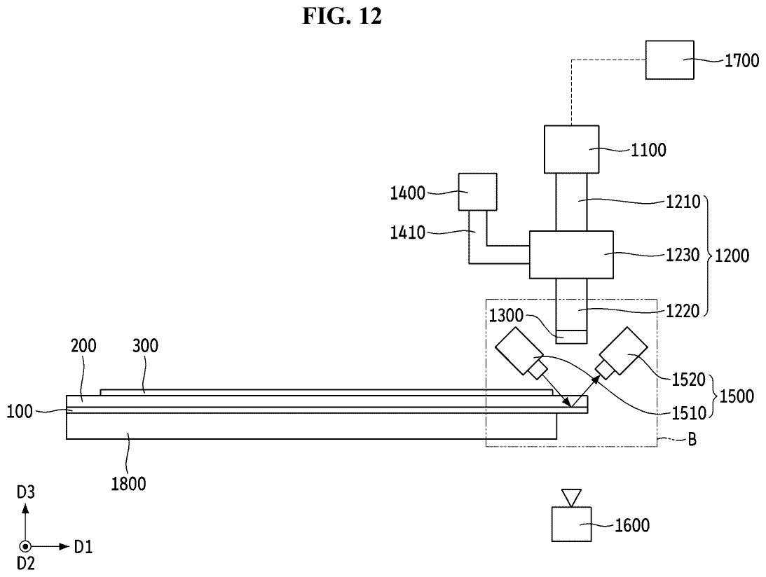

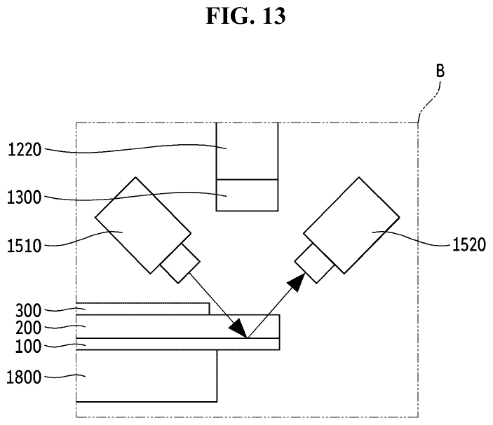

FIG. 12 is a view illustrating a state in which a focus of a camera is focused in the polarizing film inspection method according to an example embodiment of the present disclosure. FIG. 13 is an enlarged view of part B of FIG. 12.

Referring to FIGS. 12 and 13, the step of adjusting the focus of the camera 1100 onto the interface between the polarizing film 100 and the display panel 200 may include a step of emitting focused light from a light emitting portion 1510 toward the display device 10 (i.e., irradiating the display device 10 with the focused light from the light emitting portion 1510), a step of receiving the focused light reflected by the display device 10 by a light receiving portion 1520, and a step in which the control unit 1700 moves the camera 1100 such that the focused light irradiates the interface between the polarizing film 100 and the display panel 200 and is reflected by the polarizing film 100. The light emitting portion 1510 and the light receiving portion 1520 may be coupled to the camera 1100 and may move together with the camera 1100.

In the step of emitting the focused light from the light emitting portion 1510 to the display device 10, the light emitting portion 1510 may irradiate the focused light to the display device 10 in an oblique direction rather than a direction perpendicular to the display device 10.

In the step of receiving the focused light reflected by the display device 10 by the light receiving portion 1520, the light receiving portion 1520 may receive the focused light reflected by the display device 10.

In the step in which the control unit 1700 moves the camera 1100 such that the focused light irradiates the interface between the polarizing film 100 and the display panel 200 and is reflected by the polarizing film 100, the control unit 1700 may move the camera 1100 such that the focused light emitted by the light emitting portion 1510 irradiates the interface between the polarizing film 100 and the display panel 200 and the focused light reflected by the polarizing film 100 is received by the light receiving portion 1520. Since a point where the focused light emitted by the light emitting portion 1510 is reflected becomes the focus of the camera 1100, the control unit 1700 may move the camera 1100 such that the focus of the camera 1100 is positioned at the interface between the polarizing film 100 and the display panel 200.

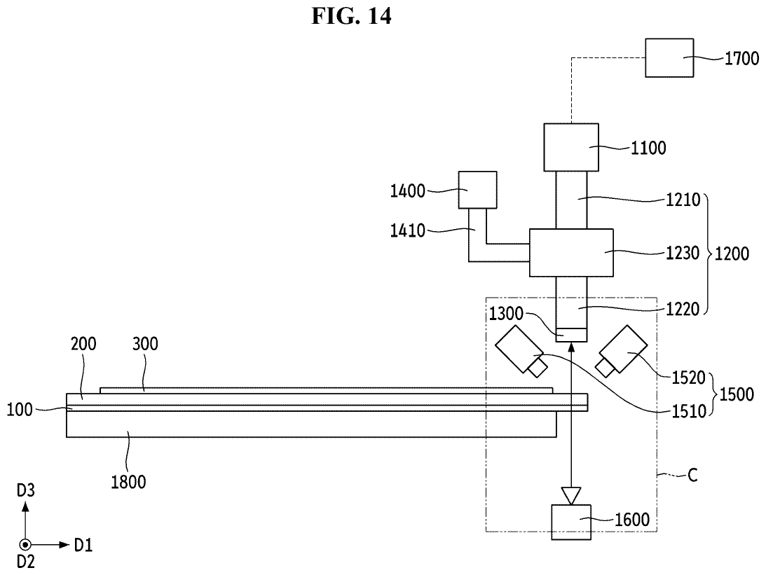

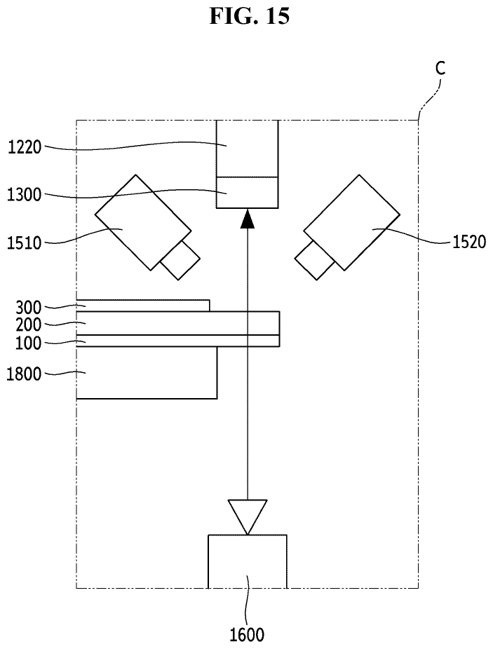

FIG. 14 is a view illustrating a state in which light emitted by the transmission lighting passes through a polarizing film and a polarizing filter and is received by the camera in the polarizing film inspection method according to an example embodiment of the present disclosure. FIG. 15 is an enlarged view of part C of FIG. 14.

The step in which the light emitted by the transmission lighting 1600 passes through the polarizing film 100 and the polarizing filter 1300 and is received by the camera 1100 may include a step in which the light irradiated by the transmission lighting 1600 passes through the polarizing film 100, a step in which the light passing through the polarizing film 100 passes through the polarizing filter 1300, a step in which the light passing through the polarizing film 100 and the polarizing filter 1300 passes through the objective lens 1220, a step in which the light passing through the objective lens 1220 passes through the tube lens 1210, and a step in which the light passing through the tube lens 1210 is received by the camera 1100.

In the step in which the light irradiated by the transmission lighting 1600 passes through the polarizing film 100, light may be irradiated from the transmission lighting 1600, and the light emitted by the transmission lighting 1600 may irradiate and be incident an edge of the polarizing film 100 and pass through the polarizing film 100.

In the step in which the light passing through the polarizing film 100 passes through the polarizing filter 1300, the polarizing filter 1300 may pass the light that has passed through the polarizing film 100 among the light emitted by the transmission lighting 1600.

In the process of the light passing through the polarizing film 100 passing through the polarizing filter 1300, light that is correctly polarized by the polarizing film 100 may be blocked by the polarizing filter 1300, and light that is incorrectly polarized by the polarizing film 100 may pass through the polarizing filter 1300.

In the step in which the light passing through the polarizing film 100 and the polarizing filter 1300 passes through the objective lens 1220, the objective lens 1220 may pass the light that has passed through the polarizing filter 1300.

In the step in which the light passing through the objective lens 1220 passes through the tube lens 1210, the tube lens 1210 may pass the light that has passed through the objective lens 1220.

In the step in which the light passing through the tube lens 1210 is received by the camera 1100, the light passing through the tube lens 1210 may be guided to the camera 1100 by the tube lens 1210 and received by the camera 1100.

In the step in which the control unit 1700 determines whether the polarizing film 100 is defective by analyzing the light received by the camera 1100, the control unit 1700 may determine whether the polarizing film 100 is defective by analyzing an image captured by the camera 1100. The control unit 1700 may determine whether the polarizing film 100 is defective or not based on whether the light emitted by the transmission lighting 1600 is present in the image captured by the camera 1100.

The control unit 1700 may determine that the polarizing film 100 is defective, based on determining that the light emitted by the transmission lighting 1600 is present in the image captured by the camera 1100. The light emitted by the transmission lighting 1600 may pass through the edge of the polarizing film 100, then pass through the polarizing filter 1300 and move to the objective lens 1220. Since the polarization angle of the polarizing filter 1300 is perpendicular to the polarization angle of the polarizing film 100, the light passing through the polarizing film 100 may be blocked by the polarizing filter 1300 when the cracks do not occur on the polarizing film 100. However, when the cracks occur on the polarizing film 100, the polarization angle may change as the light passes through the cracks, and the light with the changed polarization angle may pass through the polarizing filter 1300 and be received by the camera 1100. Therefore, when the cracks occur on the polarizing film 100, some of the light passing through the polarizing film 100 passes through the polarizing filter 1300 and is received by the camera 1100. As a result, the light may be present in the image captured by the camera 1100.

In some aspects, the control unit 1700 may determine that the polarizing film 100 is not defective, based on determining that the light emitted by the transmission lighting 1600 is not present in the image captured by the camera 1100. The light emitted by the transmission lighting 1600 may pass through the edge of the polarizing film 100, then pass through the polarizing filter 1300 and move to the objective lens 1220. Since the polarization angle of the polarizing filter 1300 is perpendicular to the polarization angle of the polarizing film 100, the light passing through the polarizing film 100 may be blocked by the polarizing filter 1300 when the cracks do not occur on the polarizing film 100. Therefore, when the cracks do not occur on the polarizing film 100, the light passing through the polarizing film 100 is blocked by the polarizing filter 1300. As a result, the light may not be present in the image captured by the camera 1100.

The display device according to an embodiment of the present disclosure can be applied to various electronic devices. The electronic device according to embodiments of the present disclosure includes the display device described herein, and may further include modules or devices having additional functions in addition to the display device.

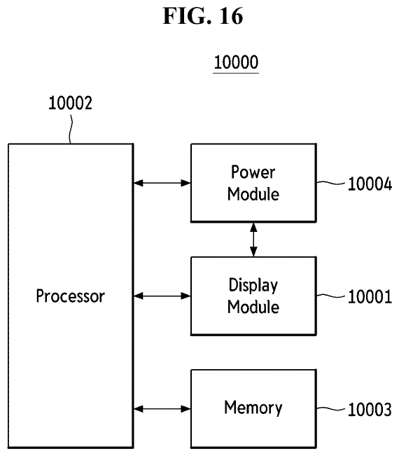

FIG. 16 is a block diagram of an electronic device according to an embodiment of the present disclosure.

Referring to FIG. 16, the electronic device 10000 according to an embodiment of the present disclosure may include a display module 10001, a processor 10002, a memory 10003, and a power module 10004.

The processor 10002 may include at least one of a central processing unit (CPU), an application processor (AP), a graphic processing unit (GPU), a communication processor (CP), an image signal processor (ISP), and a controller.

The memory 10003 may store data information for the operation of the processor 10002 or the display module 10001. In an example in which the processor 10002 executes an application stored in the memory 10003, an image data signal and/or an input control signal is transmitted to the display module 10001, and the display module 10001 can process the received signal and output image information through a display screen.

The power module 10004 may include a power supply module such as, for example, a power adapter or a battery, and a power conversion module that converts the power supplied by the power supply module to generate power for the operation of the electronic device 10000.

At least one of the components of the electronic device 10000 according to embodiments of the present disclosure may be included in the display device according to the embodiments of the present disclosure. In some aspects, some modules of the individual modules functionally included in one module may be included in the display device, and other modules may be provided separately from the display device. For example, the display device may include the display module 10001, and the processor 10002, the memory 10003, and the power module 10004 may be provided in the form of other devices within the electronic device 10000 other than the display device.

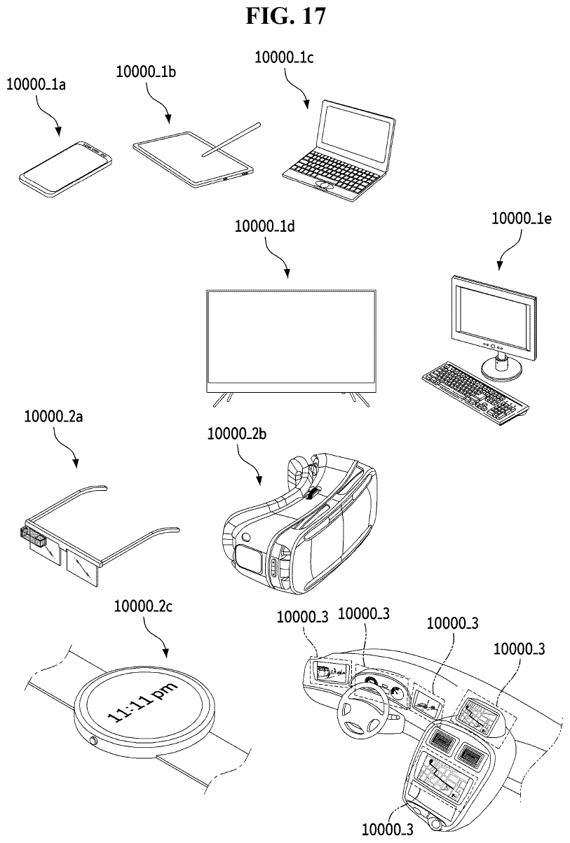

FIG. 17 is a schematic diagram of an electronic device according to various embodiments of the present disclosure.

Referring to FIG. 17, various electronic devices to which display devices according to embodiments of the present disclosure are applied may include not only image display electronic devices such as, for example, a smart phone 10000_1a, a tablet PC (personal computer) 10000_1b, a laptop 10000_1c, a TV 10000_1d, and a desk monitor 10000_1e, but also wearable electronic devices including display modules such as, for example smart glasses 10000_2a, a head mounted display 10000_2b, and a smart watch 10000_2c, and vehicle electronic devices 10000_3 including display modules such as, for example, a CID (Center Information Display) and a room mirror display arranged on a dashboard, center fascia, and dashboard of an automobile.

It should be understood, however, that the aspects and features of embodiments of the present disclosure are not restricted to the one set forth herein. The above and other aspects of the present disclosure will become more apparent to one of ordinary skill in the art to which the present disclosure pertains by referencing the claims, with equivalents thereof to be included therein.

What is claimed is:

1. A polarizing film inspection device comprising:
a jig on which a display device comprising a polarizing film and a display panel is seated;
a polarizing filter disposed on an upper portion of an edge of the polarizing film and having a polarization angle different from a polarization angle of the polarizing film;
a transmission lighting disposed on a lower portion of the edge of the polarizing film and emitting light toward the edge of the polarizing film;
a camera disposed on an upper portion of the polarizing filter; and
a control unit which determines whether the polarizing film is defective or not by analyzing an image captured by the camera.

2. The polarizing film inspection device of claim 1, wherein the polarization angle of the polarizing filter is perpendicular to the polarization angle of the polarizing film.

3. The polarizing film inspection device of claim 1, wherein the control unit determines whether the polarizing film is defective or not based on whether the light emitted by the transmission lighting is present in the image captured by the camera.

4. The polarizing film inspection device of claim 3, wherein the control unit:
determines that the polarizing film is defective, based on determining that the light emitted by the transmission lighting is present in the image captured by the camera, and
determines that the polarizing film is not defective, based on determining that the light emitted by the transmission lighting is not present in the image captured by the camera.

5. The polarizing film inspection device of claim 1, further comprising a lens portion that guides light that passes through the polarizing film among the light emitted by the transmission lighting to the edge of the polarizing film to the camera.

6. The polarizing film inspection device of claim 5, wherein the lens portion comprises:
a tube lens disposed on a lower portion of the camera;
an objective lens which is disposed at a lower portion of the tube lens and spaced apart from the tube lens; and
a lens connection portion disposed between the tube lens and the objective lens.

7. The polarizing film inspection device of claim 6, wherein the polarizing filter is disposed on a lower portion of the objective lens.

8. The polarizing film inspection device of claim 5, further comprising:
a coaxial lighting which generates alignment light; and
a lighting connection portion connecting the coaxial lighting and the lens portion,
wherein the alignment light generated from the coaxial lighting passes through the lighting connection portion and the lens portion and is transmitted toward the transmission lighting.

9. The polarizing film inspection device of claim 1, wherein the display device is seated on the jig such that the polarizing film is positioned at a lowest portion of the display device.

10. The polarizing film inspection device of claim 9, further comprising a focusing portion which adjusts a focus of the camera on an interface between the polarizing film and the display panel.

11. The polarizing film inspection device of claim 10, wherein the focusing portion comprises:
a light emitting portion which emits focused light toward the interface between the polarizing film and the display panel; and
a light receiving portion which receives the focused light reflected by the polarizing film.

12. A polarizing film inspection method comprising:
seating a display device comprising a polarizing film and a display panel on a jig;
aligning a camera and a transmission lighting;
adjusting a focus of the camera onto an interface between the polarizing film and the display panel;
passing light emitted from the transmission lighting through the polarizing film and a polarizing filter and receiving the light by the camera; and
determining, by a control unit, whether the polarizing film is defective by analyzing the light received by the camera.

13. The polarizing film inspection method of claim 12, wherein in the seating of the display device on the jig, the display device is seated on the jig such that the polarizing film is positioned at a lowest portion of the display device.

14. The polarizing film inspection method of claim 13, wherein the aligning of the camera and the transmission lighting comprises:
emitting alignment light from a coaxial lighting in an axial direction which is parallel to an axial direction of the camera; and
moving, by the control unit, the camera or the transmission lighting such that the alignment light irradiates the transmission lighting.

15. The polarizing film inspection method of claim 13, wherein the focusing of the focus of the camera onto the interface between the polarizing film and the display panel comprises:
emitting focused light from a light emitting portion toward the display device; and
receiving, by a light receiving portion, the focused light reflected by the display device.

16. The polarizing film inspection method of claim 15, wherein the focusing of the focus of the camera onto the interface between the polarizing film and the display panel comprises moving, by the control unit, the camera such that the focused light irradiates the interface of the polarizing film and the display panel and is reflected by the polarizing film.

17. The polarizing film inspection method of claim 13, wherein a polarization angle of the polarizing filter is perpendicular to a polarization angle of the polarizing film.

18. The polarizing film inspection method of claim 17, wherein the passing of the light emitted by the transmission lighting through the polarizing film and the polarizing filter and the receiving of the light by the camera comprises:
passing the light emitted by the transmission lighting through the polarizing film;
passing the light passing through the polarizing film through the polarizing filter; and
receiving the light passing through the polarizing filter with the camera,
wherein the receiving of the light passing through the polarizing filter with the camera comprises:
passing the light passing through the polarizing filter through an objective lens; and
passing the light passing through the objective lens through a tube lens and receiving the light with the camera.

19. The polarizing film inspection method of claim 13, wherein in the determining, by the control unit, whether the polarizing film is defective by analyzing the light received by the camera, the control unit:
determines that the polarizing film is defective, based on determining that the light is received by the camera, and
determines that the polarizing film is not defective, based on determining that the light is not received by the camera.

20. An electronic device comprising:
a display device which is inspected by a polarizing film inspection device,
wherein the polarizing film inspection device comprises:
a jig on which a display device comprising a polarizing film and a display panel is seated;
a polarizing filter disposed on an upper portion of an edge of the polarizing film and having a polarization angle different from a polarization angle of the polarizing film;
a transmission lighting disposed on a lower portion of the edge of the polarizing film and emitting light toward the edge of the polarizing film;
a camera disposed on an upper portion of the polarizing filter; and
a control unit which determines whether the polarizing film is defective by analyzing an image captured by the camera.
